(19) United States
(12) Patent Application Publication
(10) Pub. No.: US 2024/0095542 A1
(43) Pub. Date: Mar. 21, 2024

(54) SPLIT NEURAL NETWORK ACCELERATION ARCHITECTURE SCHEDULING AND DYNAMIC INFERENCE ROUTING

(71) Applicant: QUALCOMM Incorporated, San Diego, CA (US)

(72) Inventors: Vijaya Kumar KILARI, Bangalore (IN); Fan WU, Broomfield, CO (US); Geoffrey Carlton BERRY, Durham, NC (US); Hemanth PURANIK, Bangalore (IN)

(21) Appl. No.: 18/257,284

(22) PCT Filed: Feb. 25, 2022
(86) PCT No.: PCT/US2022/018022

§ 371 Date: Jun. 13, 2023

(30) Foreign Application Priority Data
Feb. 25, 2021 (IN) 202141007909

(51) Int. Cl. G06N 3/10; G06N 3/08

(52) U.S. Cl. CPC G06N 3/10; G06N 3/08

(57) ABSTRACT

A method for accelerating machine learning on a computing device is described. The method includes accessing a neural network. The method also includes splitting the neural network into N sub-neural networks. The method further includes hosting the N sub-neural networks in M inference accelerators. The method also includes scheduling the N sub-neural networks in the M inference accelerators. The method further includes executing the N sub-neural networks in the M inference accelerators.

### CROSS-REFERENCE TO RELATED APPLICATION

The present application claims the benefit of Indian Provisional Patent Application No. 202141007909, filed Feb. 25, 2021, and titled “SPLIT NEURAL NETWORK ACCELERATION ARCHITECTURE SCHEDULING AND DYNAMIC INFERENCE ROUTING,” the disclosure of which is expressly incorporated by reference herein in its entirety.

### TECHNICAL FIELD

Certain aspects of the present disclosure generally relate to artificial neural networks and, more particularly, to scheduling and dynamic inference routing of hardware accelerators for split artificial neural networks.

### BACKGROUND

An artificial neural network, which may include an interconnected group of artificial neurons, may be a computational device or may represent a method to be performed by a computational device. Artificial neural networks may have corresponding structure and/or function in biological neural networks. Artificial neural networks, however, may provide useful computational techniques for certain applications, in which traditional computational techniques may be cumbersome, impractical, or inadequate. Because artificial neural networks may infer a function from observations, such networks may be useful in applications where the complexity of the task and/or data makes the design of the function burdensome using conventional techniques.

In computing, hardware acceleration is the use of computer hardware to perform some functions more efficiently than is possible in software running on a more general-purpose central processing unit (CPU). The hardware that performs the acceleration may be referred to as a hardware accelerator. Hardware accelerators may improve the execution of a specific algorithm by allowing greater concurrency, having specific data-paths for temporary variables in the algorithm, and possibly reducing the overhead of instruction control. Techniques for scheduling and dynamic inference routing of hardware accelerators for split artificial neural networks are desired.

### SUMMARY

A method for accelerating machine learning on a computing device is described. The method includes accessing a neural network. The method also includes splitting the neural network into N sub-neural networks. The method further includes hosting the N sub-neural networks in M inference accelerators. The method also includes scheduling the N sub-neural networks in the M inference accelerators. The method further includes executing the N sub-neural networks in the M inference accelerators.

A non-transitory computer-readable medium having program code recorded thereon for accelerating machine learning on a computing device is described. The program code is executed by a processor of the computing device. The non-transitory computer-readable medium includes program code to access a neural network. The non-transitory computer-readable medium also includes program code to split the neural network into N sub-neural networks. The non-transitory computer-readable medium further includes program code to host the N sub-neural networks in M inference accelerators. The non-transitory computer-readable medium also includes program code to schedule the N sub-neural networks in the M inference accelerators. The non-transitory computer-readable medium further includes program code to execute the N sub-neural networks in the M inference accelerators.

A method for dynamic inference routing of accelerated machine learning on a computing device is described. The method includes splitting a neural network into a first sub-neural network and a second sub-neural network. The method also includes hosting the first sub-neural network in a first inference accelerator and the second sub-neural network in a second inference accelerator. The method further includes monitoring the first inference accelerator and the second inference accelerator. The method also includes performing an output redirection decision of the first sub-neural network and/or the second sub-neural network according to a predetermined performance criteria.

A non-transitory computer-readable medium having program code recorded thereon for dynamic inference routing of accelerated machine learning on a computing device is described. The program code is executed by a processor of the computing device. The non-transitory computer-readable medium includes program code to split a neural network into a first sub-neural network and a second sub-neural network. The non-transitory computer-readable medium also includes program code to host the first sub-neural network in a first inference accelerator and the second sub-neural network in a second inference accelerator. The non-transitory computer-readable medium further includes program code to monitor the first inference accelerator and the second inference accelerator. The non-transitory computer-readable medium also includes program code to perform an output redirection decision of the first sub-neural network and/or the second sub-neural network according to a predetermined performance criteria.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-chip (SoC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating a neural network, in accordance with aspects of the present disclosure.

FIG. 3 is a block diagram illustrating a neural network acceleration architecture, in accordance with aspects of the present disclosure.

FIG. 4 is a block diagram illustrating control flow and data flow in a neural network acceleration architecture, in accordance with aspects of the present disclosure.

FIG. 5 is a block diagram illustrating control flow and data flow in a neural network acceleration architecture, in accordance with aspects of the present disclosure.

FIG. 6 is a block diagram illustrating control flow and data flow in a neural network acceleration architecture, in accordance with further aspects of the present disclosure.

FIG. 7 is a block diagram illustrating a neural network acceleration architecture in a daisy chain configuration, in accordance with aspects of the present disclosure.

FIG. 8 is a block diagram further illustrating the neural network acceleration architecture of FIG. 7 in the daisy chain configuration, in accordance with aspects of the present disclosure.

FIG. 9 is a block diagram illustrating a neural network acceleration architecture in a mesh configuration, in accordance with aspects of the present disclosure.

FIG. 10 is a block diagram illustrating input ports and output ports of a neural network acceleration architecture, in accordance with aspects of the present disclosure.

FIG. 11 is a block diagram further illustrating configuration of input ports and output ports of the neural network acceleration architecture of FIG. 10, in accordance with aspects of the present disclosure.

FIG. 12 is a block diagram illustrating a scheduler policy generation flow for neural network acceleration architectures, in accordance with aspects of the present disclosure.

FIG. 13 is a block diagram further illustrating the scheduler policy generation flow of FIG. 12, in accordance with aspects of the present disclosure.

FIG. 14 is a block diagram illustrating the schedule table generation for the scheduler policy generation flow of FIG. 12, in accordance with aspects of the present disclosure.

FIG. 15 is a block diagram illustrating a scheduler policy generation for sub-neural networks of a neural network acceleration architecture, in accordance with aspects of the present disclosure.

FIG. 16 is a block diagram illustrating a port information table for sub-neural networks of a neural network acceleration architecture, in accordance with aspects of the present disclosure.

FIG. 17 is a block diagram illustrating configuration connections of sub-neural networks for data flow path of a neural network acceleration architecture, in accordance with aspects of the present disclosure.

FIG. 18 is a block diagram illustrating host control path monitoring of a neural network acceleration architecture, in accordance with aspects of the present disclosure.

FIG. 19 is a block diagram illustrating an output port deployment of sub-neural networks of a neural network acceleration architecture, in accordance with aspects of the present disclosure.

FIG. 20 is a block diagram illustrating an output port redirection of sub-neural networks of a neural network acceleration architecture, in accordance with aspects of the present disclosure.

FIG. 21 is a block diagram illustrating an output port deployment of sub-neural networks of a neural network acceleration architecture having multiple instances of the same sub-neural network, in accordance with aspects of the present disclosure.

FIG. 22 illustrates a method for scheduling accelerating of machine learning on a computing device, in accordance with aspects of the present disclosure.

FIG. 23 illustrates a method for dynamic inference routing of accelerated machine learning on a computing device, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. Nevertheless, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

Although particular aspects are described, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure, rather than limiting the scope of the disclosure being defined by the appended claims and equivalents thereof.

An example of accelerated deep learning uses a deep learning accelerator (e.g., an artificial intelligence inference accelerator) to train a neural network. Another example of accelerated deep learning uses a deep learning accelerator to operate a trained neural network to perform inferences. Yet another example of accelerated deep learning is using a deep learning accelerator to train a neural network and, subsequently, perform an inference with the trained neural network. The inference is also performed with information from the trained neural network and/or a variant of the trained neural network.

As noted, an artificial intelligence accelerator may be used to train a neural network. Training of a neural network generally involves determining one or more weights associated with the neural network. For example, the weights associated with a neural network are determined by hardware acceleration using a deep learning accelerator. Once the weights associated with a neural network are determined, an inference may be performed using the trained neural network, which computes results (e.g., activations) by processing input data based on the weights associated with the trained neural network.

In practice, however, a deep learning accelerator has a fixed amount of memory (e.g., static random access memory (SRAM) with a capacity of 128 megabytes (MB)). As a result, the capacity of a deep learning accelerator is sometimes not large enough to accommodate and store a single network. For example, some networks have weights of a larger size than the fixed amount of memory available from the deep learning accelerator. One solution to accommodate large networks is to split the weights into a separate storage device (e.g., a dynamic random access memory (DRAM)). These weights are then read from the DRAM during each inference. This implementation, however, uses more power and can result a memory bottleneck.

Another solution to accommodate large networks is splitting the network into multiple pieces and passing intermediate results from one accelerator to another through a host. Unfortunately, passing intermediate inference request results through the host consumes host bandwidth. For example, using a host interface (e.g., a peripheral component interconnect express (PCIe) interface) to pass intermediate inference request results consumes the host memory bandwidth. In addition, passing intermediate inference request results through the host (e.g., a host processor) consumes central processing unit cycles of the host processor and adds latency to an overall inference calculation.

To solve this problem, some aspects of the present disclosure split a large neural network into multiple, separate artificial intelligence (AI) inference accelerators (AIIAs). Each of the separate AI inference accelerators may be implemented in a separate system-on-chip (SoC). For example, each AI inference accelerator is allocated and stores a fraction of the weights or other parameters of the neural network. Intermediate inference request results are passed from one AI inference accelerator to another AI inference accelerator independent of a host processor. Thus, the host processor is not involved with the transfer of the intermediate inference request results.

A designated AI inference accelerator of the AI inference accelerators may directly communicate with the host (e.g., host processor). For example, a non-designated AI inference accelerator communicates with the host processor through the designated AI inference accelerator. The separate AI inference accelerators are also coupled to a peripheral interface or a server. The separate AI inference accelerators may be implemented in a same or different module (or card) or in a same or different package.

In addition, a switch device (e.g., a peripheral component interconnect express (PCIe) switch or other like peripheral interconnect switch) may be coupled to the separate AI inference accelerators to transfer the intermediate inference request results between the separate AI inference accelerators without involving the host processor. Thus, each of the separate artificial intelligence inference accelerators collectively performs an inference for a neural network that is split between separate artificial intelligence inference accelerators.

Nevertheless, a scheduling policy is important for running the neural networks in a multi-device mode, in which the neural networks are split into sub-neural networks. In operation, a compiler generates sub-neural networks that run independently on the device. An entity is desired for defining and/or deriving a scheduling policy (e.g., an execution plan that runs multiple sub-neural networks on multiple devices. In aspects of the present disclosure, a scheduling policy directs the devices to establish a control path and a data flow path with peer-to-peer devices. In aspects of the present disclosure, the scheduling policy supports various topologies, which varies from simple daisy chained devices to a mesh of devices. In these aspects of the present disclosure, the scheduling policy extends to any ‘n’ number of devices. In addition, the scheduling policy helps set the data path and control path among the devices prior to running an inference.

In operation, power consumption of AIIA devices depends on the load of the AIIA devices. For example, massive neural networks involve co-processors to perform floating point operations as well as matrix/vector operations. Unfortunately, performing floating point and matrix/vector operations significantly increases the power consumption and the temperature of AIIA devices. In some aspects of the present disclosure, neural networks are split into compute intensive sub-neural networks and non-compute intensive sub-neural networks. Unfortunately, the compute intensive sub-neural networks are slower, which hinders the AIIA device performance.

In some aspects of the present disclosure, a neural network is split into sub-neural networks and runs on multiple AIIA devices, in which the same instances of the sub-neural networks are run on multiple AIIA devices by dynamically routing the data flow. In these aspects of the present disclosure, dynamic routing provides significant control over AIIA device power consumption and temperature. For example, improved performance is achieved by platform software the redirects the AIIA device inputs using output port information. In these aspects of the present disclosure, a neural network, prior to choosing an output, determines when platform software redirection information is detected. In response to detected redirection information, the neural network triggers/wakes a peer output port corresponding to the redirection information. In this example, the platform software running on a host continuously monitors the AIIA devices and outputs a redirection decision to reduce power consumption and/or temperature.

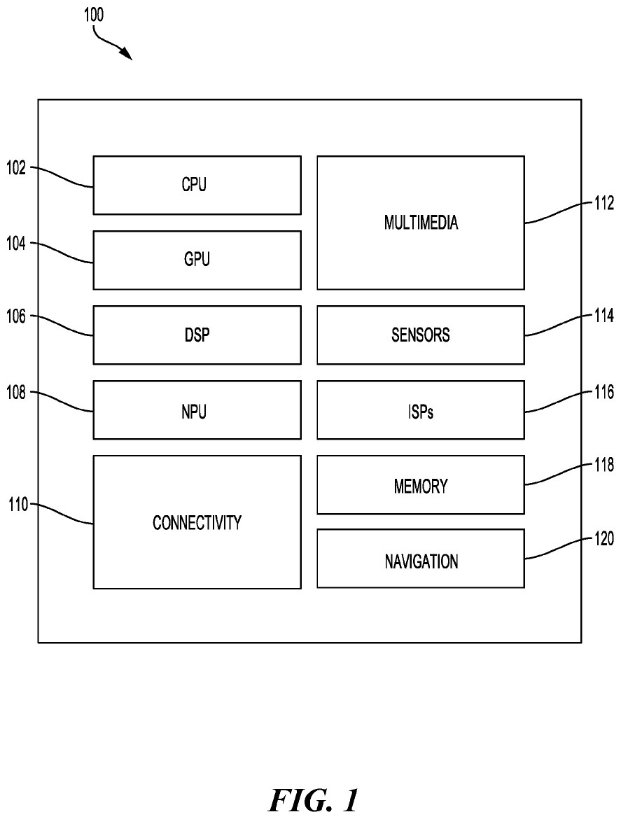

FIG. 1 illustrates an example implementation of a system-on-chip (SoC) 100, which may include a central processing unit (CPU) 102 or multi-core CPUs, in accordance with certain aspects of the present disclosure, such as split network acceleration. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a connectivity block 110, which may include fifth generation (5G) connectivity, fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SoC 100 may also include a sensor processor 114, image signal processors (ISPs) 116, and/or navigation module 120, which may include a global positioning system.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

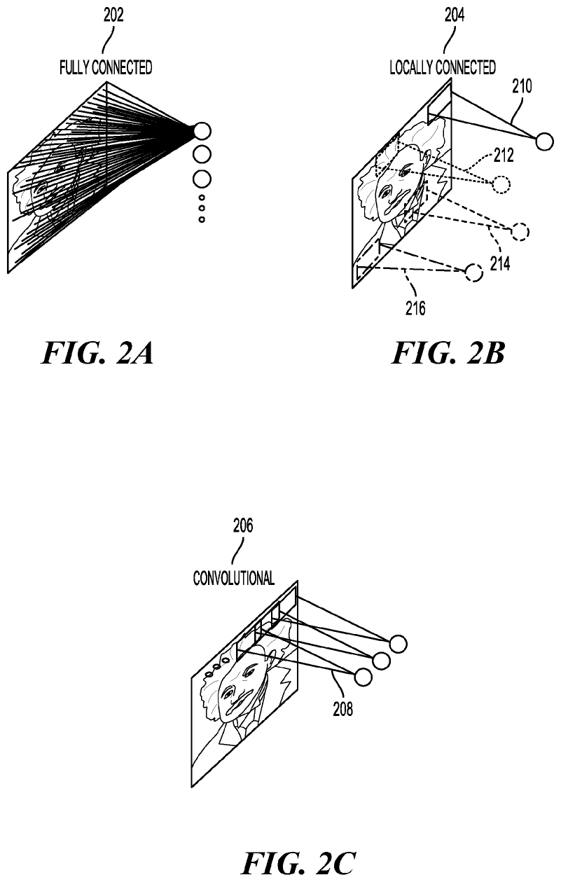

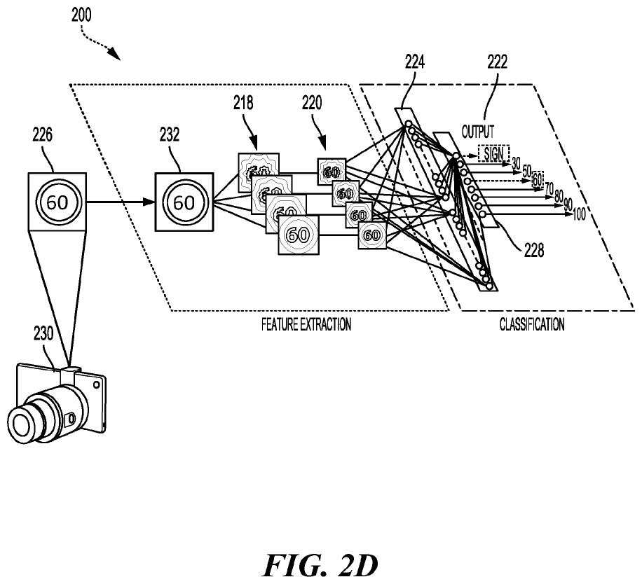

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connection strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different convolutional kernels were applied to the image 226 at the convolutional layer 232, four different feature maps are generated in the first set of feature maps 218. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100.” Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

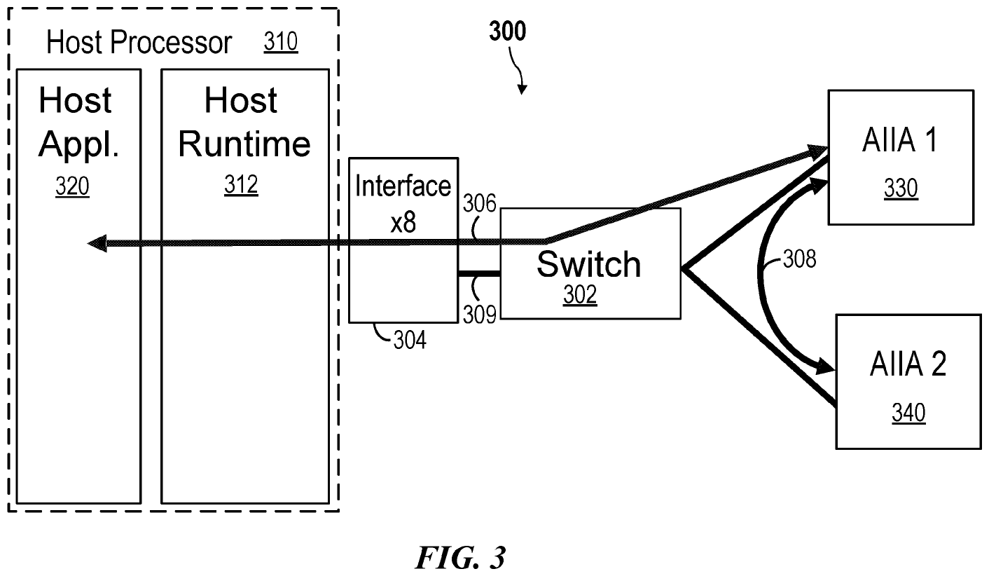

FIG. 3 is a block diagram illustrating a neural network acceleration architecture 300, in accordance with aspects of the present disclosure. The neural network acceleration architecture 300 includes a first AI inference accelerator (e.g., first AIIA 330), a second AI inference accelerator (e.g., second AIIA 340), and a host processor 310. In this configuration, the host processor 310 includes a host runtime block 312 to execute a host application 320 to operate a neural network. In this example, the neural network of the host application 320 is split and executed on the first AIIA 330 and the second AIIA 340, which provides better cache residence, leading to better performance.

According to this aspect of the present disclosure, the neural network of the host application 320 is split across the first AIIA 330 and the second AIIA 340. That is, the neural network of the host application 320 is hosted in the first AIIA 330 and the second AIIA 340. Splitting of the neural network of the host application 320 between the first AIIA 330 and the second AIIA 340, however, involves routing of intermediate inference request results 308 generated by the first AIIA 330 and/or the second AIIA 340. In this example, the intermediate inference request results 308 are routed between the first AIIA 330 and the second AIIA 340 independent of the host processor 310. As should be recognized, the intermediate inference request results 308 are intermediate results to generate an inference request result 306.

The inference request result 306 is provided to the host processor 310 through a designated inference accelerator of the first AIIA 330 and the second AIIA 340. In this configuration, a non-designated inference accelerator (e.g., the second AIIA 340) communicates with the host processor 310 via the designated inference accelerator (e.g., the first AIIA 330). For example, the inference request result 306 may be generated by the first AIIA 330, in which the inference request result 306 is based on the intermediate inference request results 308 received from the second AIIA 340.

In one aspect of the present disclosure, the routing of the intermediate inference request results 308 is based on an address implementation applied by a switch device 302, including a peripheral interface 304 (e.g., an ×8 peripheral interface). In this configuration, the switch device 302 (e.g., a peripheral component interconnect express (PCIe) switch) is coupled to the first AIIA 330 and the second AIIA 340 through a peripheral interconnect 309. The switch device 302 is coupled to the host processor 310 via the peripheral interface 304 (e.g., a PCIe ×8 interface).

According to this aspect of the present disclosure, the switch device 302 supports peer-to-peer communication between the first AIIA 330 and the second AIIA 340 to enable direct memory access (DMA) transfer without intervention from the host processor 310. In one configuration, the switch device 302 (e.g., a PCIe switch) is configured to route based on an address range. For example, a peer-to-peer address range is set up for which the data is transferred by the switch device 302 in a peer-to-peer manner. In this configuration, inbound address translation units (iATUs) in the first AIIA 330 and the second AIIA 340 are set to map the local addresses to the peer-to-peer address space (e.g., a PCIe address space of the switch device 302). This switching is transparent to, for example, an endpoint in the first AIIA 330 and/or the second AIIA 340. DMA transfers are set up with the appropriate addresses that target locations in the peer-to-peer device. In addition, base address registers (BARs) in the first AIIA 330 and/or the second AIIA 340 may provide an access window to peer AIIAs, such as the first AIIA 330 and/or the second AIIA 340.

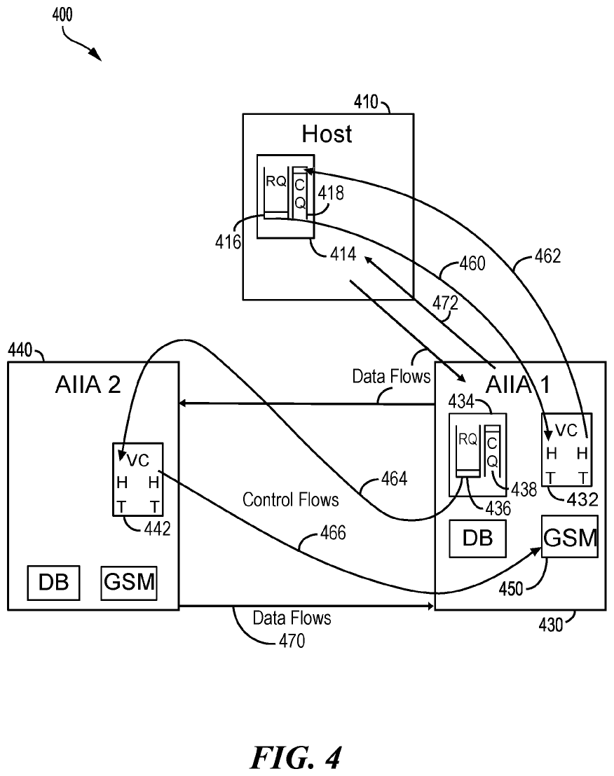

For example, the switch device 302 supports mapping of local addresses of the first AIIA 330 and the second AIIA 340 to exchange the intermediate inference request results 308 without intervention from the host processor 310. In some aspects, data from the host processor 310 may be accessed by the first AIIA 330 based on the noted DMA implementation. Similarly, data from the first AIIA 330 may be accessed by the second AIIA 340 based on the noted DMA implementation, as further illustrated in FIG. 4.

FIG. 4 is a block diagram illustrating control flow and data flow in a neural network acceleration architecture, in accordance with aspects of the present disclosure. In this configuration, a neural network acceleration architecture 400 may be similar to the neural network acceleration architecture 300 shown in FIG. 3. In this example, data accessed by a first AIIA 430 may be through a pointer stored in a request queue (RQ) 416 in a memory 414 of a host 410 (e.g., a host processor). Inference inputs (e.g., pointers) are queued in the RQ 416. When it is determined that pointers to data exists in the RQ 416, the data is transferred and received at a virtual channel (e.g., VC 432) of the first AIIA 430, as shown by a first control flow 460. In addition, an inference request result is provided to a completion queue (QC) 418 of the host 410 from the first AIIA 430, as shown by a second control flow 462.

As further illustrated in FIG. 4, a second AIIA 440 also includes a virtual channel (e.g., VC 442) through which data is received by the second AIIA 440, as shown by a third control flow 464, and transmitted by the second AIIA 440, as shown by a fourth control flow 466. One way to communicate the inference request result from the first AIIA 430 to the host 410 is through a global synchronization manager (GSM) 450 of the first AIIA 430. The first AIIA 430 may also include a request queue (RQ) 436 and a completion queue (CQ) 438 in a memory 434 of the first AIIA 430.

According to this configuration, the host 410 is the driver for control flows and data flows of the first AIIA 430 using the RQ 416 and the CQ 418 in the memory 414 of the host 410. Similarly, the first AIIA 430 is the driver for control flows and data flows of the second AIIA 440 using the RQ 436 and the CQ 438 in the memory 434 of the first AIIA 430. For example, a network signal processor (NSP) (not shown) of the first AIIA 430 generates an RQ element in the RQ 436 within the memory 434 of the first AIIA 430 for DMA of inputs to the second AIIA 440.

In this example, the NSP of the first AIIA 430 generates an additional RQ element in the RQ 436 for DMA of results from the second AIIA 440 (see data flow 470). The additional RQ element may have a final DMA (e.g., a doorbell (DB)) that can write to a sync manager (e.g., GSM 450) in the first AIIA 430. Writing to the GSM 450 may be performed by the second AIIA 440 using an interconnect protocol (e.g., a peripheral component interconnect (PCI) protocol), as shown by the fourth control flow 466. An RQ tail (T) pointer is incremented in the VC 442 of the second AIIA 440 using, for example, the third control flow 464. In some aspects of the present disclosure, the producer sets the GSM 450 in the consumer to specify the availability of the input data. In addition, the consumer sets the doorbell (DB) once the input buffer is consumed.

In this configuration, operation of the second AIIA 440 assumes communication with the host 410; however, a host address for this communication is mapped to the first AIIA 430. Once intermediate results are completed by the second AIIA 440, the doorbell (DB) to the GSM 450 in the first AIIA 430 is written across the switch device 302, as shown in FIG. 3. A DMA channel established in the first AIIA 430 may be assigned a pre-synchronization condition to DMA an inference request result back to the host 410, as shown by a data flow 472.

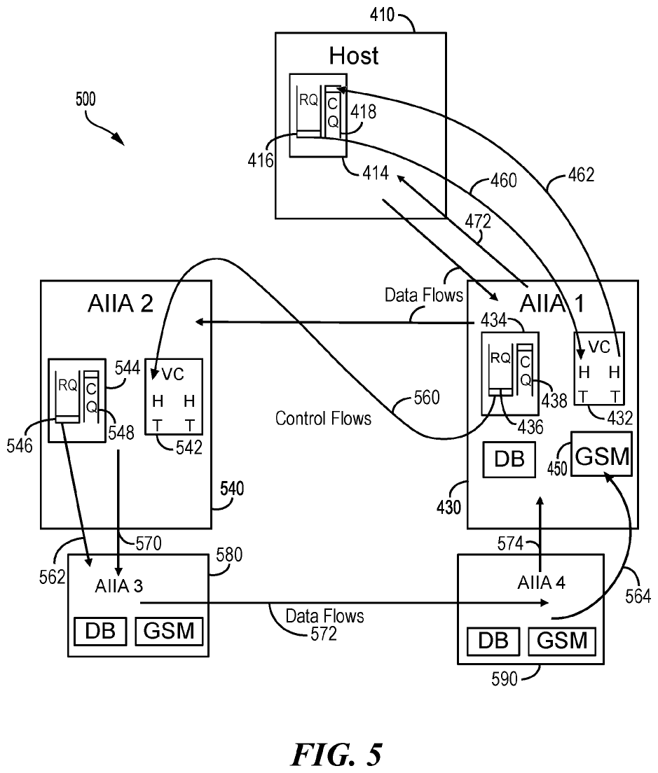

FIG. 5 is a block diagram illustrating control flow and data flow in a neural network acceleration architecture, in accordance with aspects of the present disclosure. In this configuration, a neural network acceleration architecture 500 may be similar to the neural network acceleration architecture 400 shown in FIG. 4, including the host 410 and the first AIIA 430. In this configuration, a second AIIA 540 includes a virtual channel (e.g., VC 542) as well as a memory 544, including a request queue (e.g., RQ 546) and a command queue (CQ) 548. The neural network acceleration architecture 500 further includes a third AIIA 580 and a fourth AIIA 590.

In operation, data accessed by the second AIIA 540 may come from the RQ 436 in the memory 434 of the first AIIA 430. Inference inputs are queued in the RQ 436. When it is determined that data exists in the RQ 436, the data is transferred and received at the VC 542 of the second AIIA 540, as shown by a control flow 560. In addition, data accessed by the third AIIA 580 may come from the RQ 546 in the memory 544 of the second AIIA 540. Inference inputs are queued in the RQ 546. When it is determined that data exists in the RQ 546, the data is transferred and received at the third AIIA 580, as shown by a control flow 562. When an intermediate inference request result is stored in the completion queue CQ 548 of the second AIIA 540, the intermediate inference request result is passed from the second AIIA 540 to the third AIIA 580, as shown by a data flow 570.

Once intermediate results are completed by the third AIIA 580, the intermediate inference request results are written to the fourth AIIA 590. Once intermediate results are completed by the fourth AIIA 590, the fourth AIIA 590 may use a doorbell (DB) mechanism to the GSM 450 in the first AIIA 430, such that the intermediate results are written across the switch device 302 (FIG. 3), as shown by a data flow 574. A DMA channel established in the first AIIA 430 may be assigned a pre-synchronization condition to DMA an inference request result back to the host 410, as shown by the data flow 472. The configuration of the neural network acceleration architecture 500 includes additional computing power provided by the addition of the third AIIA 580 and the fourth AIIA 590. Unfortunately, a circular data movement shown by data flows 570, 572, and 574 to provide the inference request result to the first AIIA 430 involves an extra data transfer, as shown by the data flow 574.

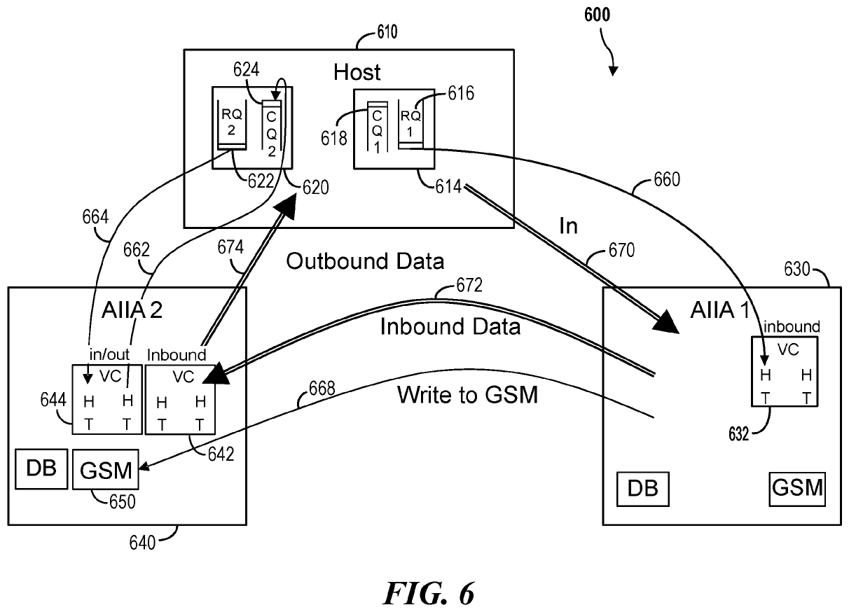

FIG. 6 is a block diagram illustrating control flow and data flow in a neural network acceleration architecture, in accordance with aspects of the present disclosure. In one configuration, a neural network acceleration architecture 600 may be similar to the neural network acceleration architecture 400 shown in FIG. 4. In one configuration, the neural network acceleration architecture 600 includes a host 610, a first AIIA 630, and a second AIIA 640. In this configuration, the host 610 controls both the first AIIA 630 and the second AIIA 640, which eliminates an extra data transfer relative to the neural network acceleration architecture 400 shown in FIG. 4. The neural network acceleration architecture 600, however, involves an additional cost for having a host interface with the first AIIA 630 and a host interface with the second AIIA 640.

In this aspect of the present disclosure, the first AIIA 630 includes a first request queue (RQ1) 616 and a first complete queue (CQ1) 618 in a first host memory 614. In this configuration, the host 610 is the driver (see control flow 660) for an input data transfer 670 (In) from the host 610 to the first AIIA 630. In addition, the first AIIA 630 includes a virtual channel (VC) 632 for the input data transfer 670, including head (H) and tail (T) pointers to organize the input data transfer 670 to generate an intermediate inference request result for the first part of the neural network.

In this configuration, the second AIIA 640 includes a second request queue (RQ2) 622 and a second complete queue (CQ2) 624 in a second host memory 620. In addition, the second AIIA 640 includes a first virtual channel (VC) 642 for an inbound data transfer 672 from the first AIIA 630 and an outbound data transfer 674 to the host 610. In this example, the first VC 642 includes head (H) and tail (T) pointers to organize the inbound data transfer 672 and the outbound data transfer 674 to generate an intermediate inference request result for a second part of the neural network. In this configuration, the first AIIA 630 is the driver for the inbound data transfer 672, in which data movement is from the first AIIA 630 to the second AIIA 640.

In operation, for a single inference request, the host 610 is specified to place an inbound request in a first request queue RQ1 616 for the inputs to compute the single inference request. In addition, the host 610 is further configured to place an inbound request in the second request queue RQ2 622 for the transfer of intermediate inference request results from the first AIIA 630 to the first VC 642 of the second AIIA 640. The host 610 is also configured to place an outbound request in the second request RQ2 622 for the inference request results. Transfer of the intermediate inference request results is performed after the first AIIA 630 completes inference of an assigned portion of a neural network.

In this aspect of the present disclosure, once the inference for the first half of the neural network is completed, the first AIIA 630 may write a value to a semaphore in the second AIIA 640 (e.g., greater than the stored value by one (1)); however, the first AIIA 630 may not know a value of the semaphore in the second AIIA 640. The first AIIA 630 may increment a semaphore in the second AIIA 640 by writing across a switch device (not shown) to a GSM 650 in the second AIIA 640, as shown by a control flow 668. In this configuration, the second AIIA 640 performs a pre-synchronization condition when the semaphore reaches a predetermined value. For example, the second AIIA 640 initiates a DMA transfer to move data according to a request queue element (RQE) in the second request RQ2 622, as shown by control flows 662 and 664 between the second host memory 620 and a second VC 644 of the second AIIA 640. In this configuration, the second AIIA 640 writes to a doorbell (DB) register of a network signal processor (NSP) memory (e.g., according to RQE) to notify the NSP that processing of the intermediate results can begin in the second half of the network. The notification to the host 610 of completion of the final inference request result is performed by placing an entry in the second command queue (CQ2) 624 and incrementing a CQ2 tail pointer, as shown by control flows 662 and 664 from a second VC 644 of the second AIIA 640.

A scheduling policy is important for running the neural networks in a multi-device mode, in which the neural networks are split into sub-neural networks. In operation, a compiler generates sub-neural networks that run independently on the device. An entity is desired for defining and/or deriving a scheduling policy (e.g., an execution plan that runs multiple sub-neural networks on multiple devices. In aspects of the present disclosure, a scheduling policy directs the devices to establish a control path and a data flow path with peer-to-peer devices. In aspects of the present disclosure, the scheduling policy supports various topologies, which vary from simple daisy chained devices to a mesh of devices. In these aspects of the present disclosure, the scheduling policy extends to any ‘n’ number of devices. In addition, the scheduling policy helps set the data path and control path among the devices prior to running an Inference.

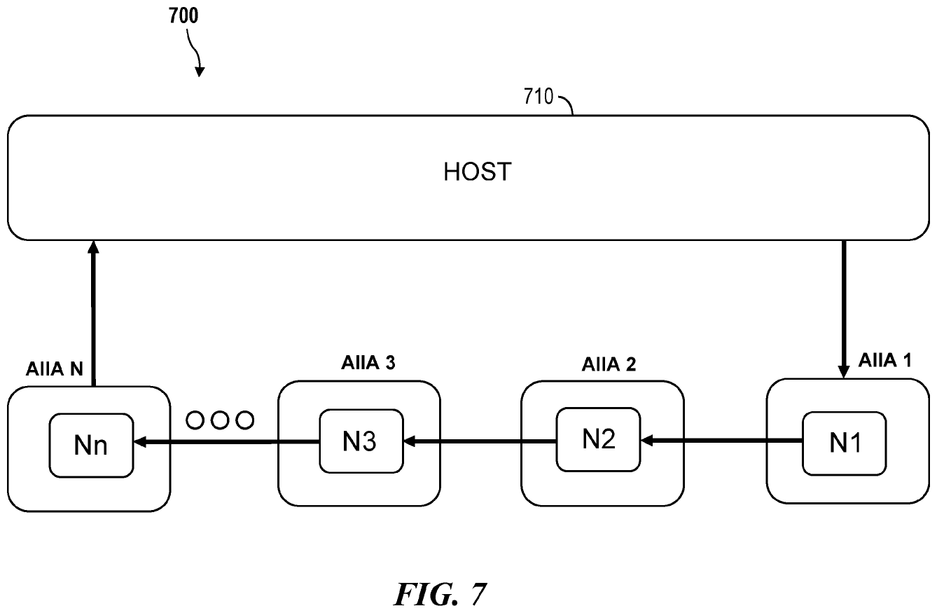

FIG. 7 is a block diagram illustrating a neural network acceleration architecture 700 in a daisy chain configuration, in accordance with aspects of the present disclosure. In this example, a neural network N is split into multiple sub-networks. For example, the neural network N is split into sub-neural networks N1, N2, N3, . . . , Nn, each executed with a respective AIIA device (e.g., AIIA 1, AIIA 2, AIIA 3, . . . , AIIA N). In this daisy chain configuration, the sub-neural network N1 receives an input from a host 710 that is processed through the sub-neural networks N2 and N3 until the sub-neural network Nn generates an output for the host 710.

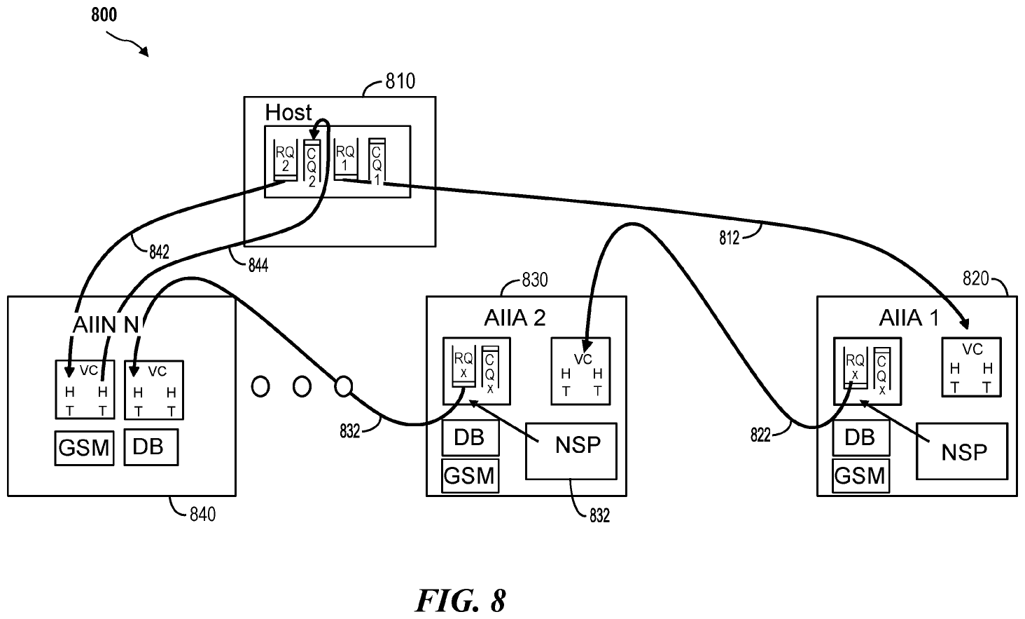

FIG. 8 is a block diagram illustrating a neural network acceleration architecture 800 in a daisy chain configuration, in accordance with aspects of the present disclosure. In one configuration, the neural network acceleration architecture 800 may be similar to the neural network acceleration architecture 600 shown in FIG. 6. In this example, a neural network N is split into sub-neural networks N1, N2, . . . , Nn, each executed with a respective AIIA device (e.g., AIIA 1 device 820, AIIA 2 device 830, . . . , AIIA N device 840). The AIIA 1 device 820 is configured with a virtual channel (VC), including a head (H) and tail (T) pointer for receiving input information from a host 810. A neural signal processor (NSP) processes commands from a command queue (CQx) and issues requests 822 to the AIIA 2 device 830 using a request queue (RQx). The AIIA 2 device 830 is shown in a similar configuration and issues requests 832 to the AIIA N device 840. In this daisy chain configuration, the AIIA 1 device 820 receives an input 812 from the host 810, which is processed through the AIIA 2 device 830 until the AIIA N device 840 generates an output 844 in response to an input 842 for the host 810.

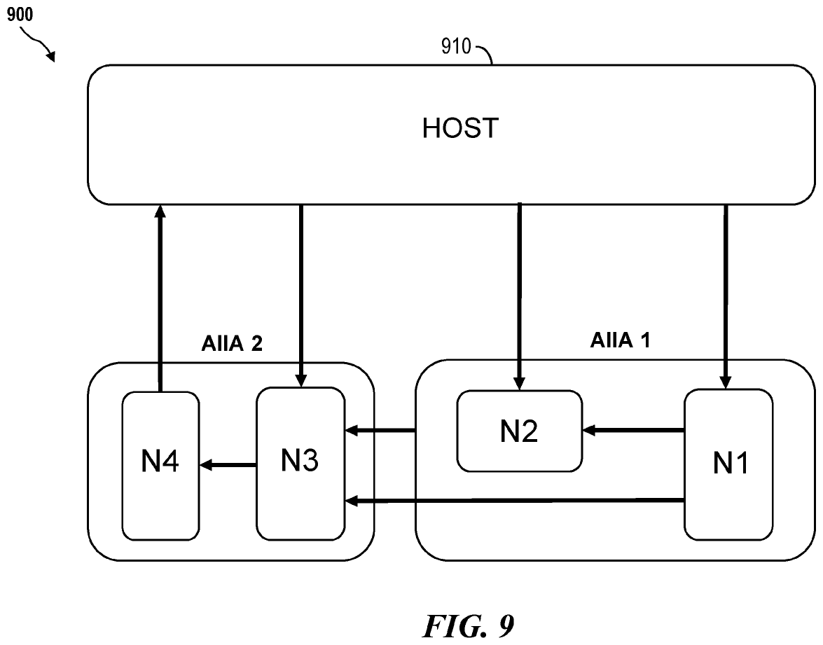

FIG. 9 is a block diagram illustrating a neural network acceleration architecture 900 in a mesh configuration, in accordance with aspects of the present disclosure. A neural network N is split into sub-neural networks N1, N2, N3, and N4; however, the sub-neural networks are configured between an AIIA 1 device and an AIIA 2 device in this mesh configuration. In this example, the sub-neural networks N1 and N2 are executed in the AIIA 1 device, and the sub-neural networks N3 and N4 are executed in the AIIA 2 device for communication with a host 910.

Conventional network execution planning is performed at compile time, which lacks flexibility. In aspects of the present disclosure, neural network execution is planned at runtime, rather than compile time, according to a scheduling policy for achieving better performance and power efficiency. As shown in FIGS. 7-9, the networks can have inputs from multiple different sources, and the network can output to different sources that are planned at runtime to improve network performance. According to aspects of the present disclosure, a scheduling policy is described to handle both simple daisy chain configurations, as shown in FIGS. 7 and 8, and complex (acyclic) control and data flow paths of mesh configurations, as shown in FIG. 9. The scheduling policy may extend to any ‘n’ number of devices.

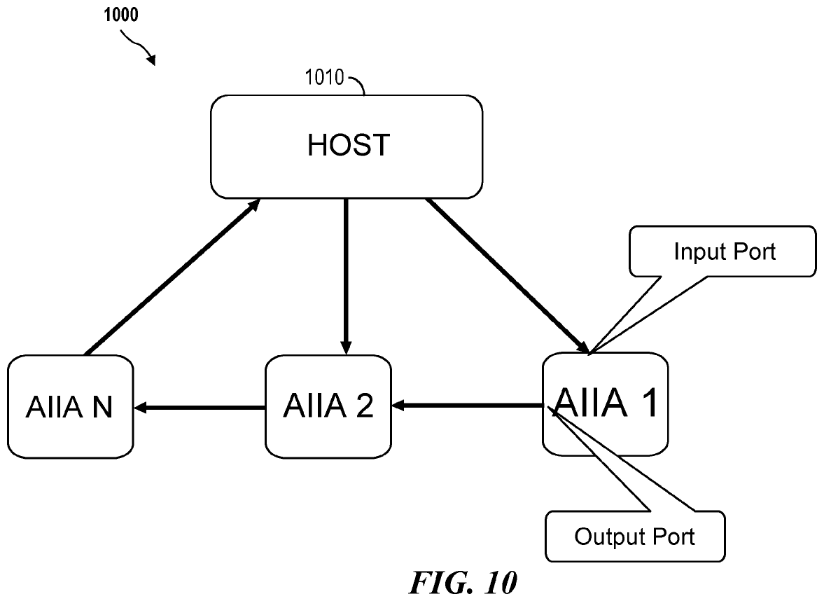

FIG. 10 is a block diagram illustrating input ports and output ports of a neural network acceleration architecture, in accordance with aspects of the present disclosure. A neural network acceleration architecture 1000 is configured with a host 1010, an AIIA 1 device, an AIIA 2 device, . . . , and an AIIA N device. In addition, an input port and an output port of the AIIA 1 device are highlighted. The multi-device, sub-neural networks shown in FIG. 10 may take inputs from more than one sub-neural network (e.g., host/remote/local). As described, input source and output destinations are treated as ports. For example, the host 1010 assigns each port a unique port identification (ID). According to aspects of the present disclosure, sub-neural network connections are described using a port ID.

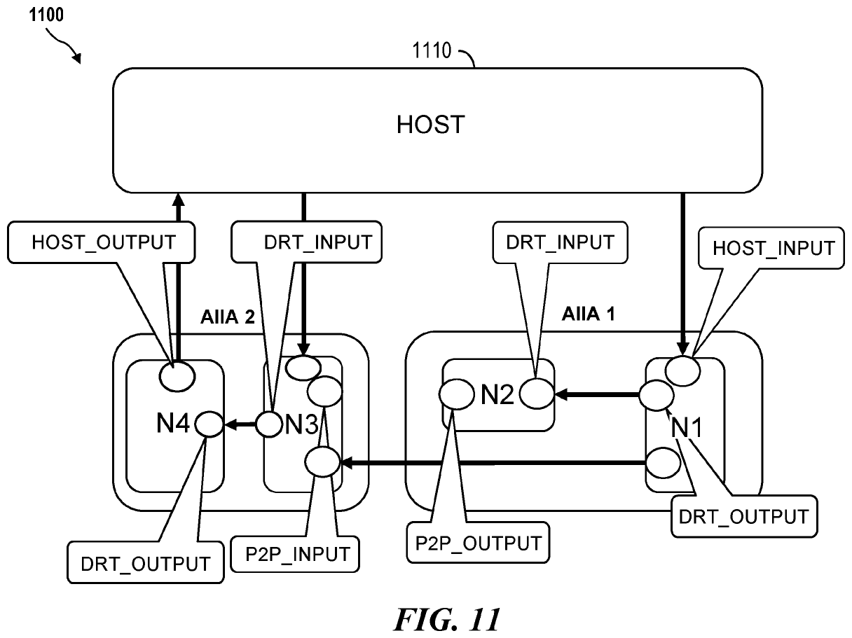

FIG. 11 is a block diagram further illustrating configuration of input ports and output ports of the neural network acceleration architecture of FIG. 10, in accordance with aspects of the present disclosure. In this configuration, the sub-neural networks can take input from three different sources: (1) a host 1100 (HOST INPUT), (2) a peer-to-peer device (P2P_INPUT), and (3) a local/device resident tensor (DRT INPUT). In addition, the sub-neural networks can output to different sinks: (1) the host (HOST_OUTUT), (2) a peer-to-peer device (P2P_OUTPUT), and (3) a local/device resident tensor (DRT_OUTPUT).

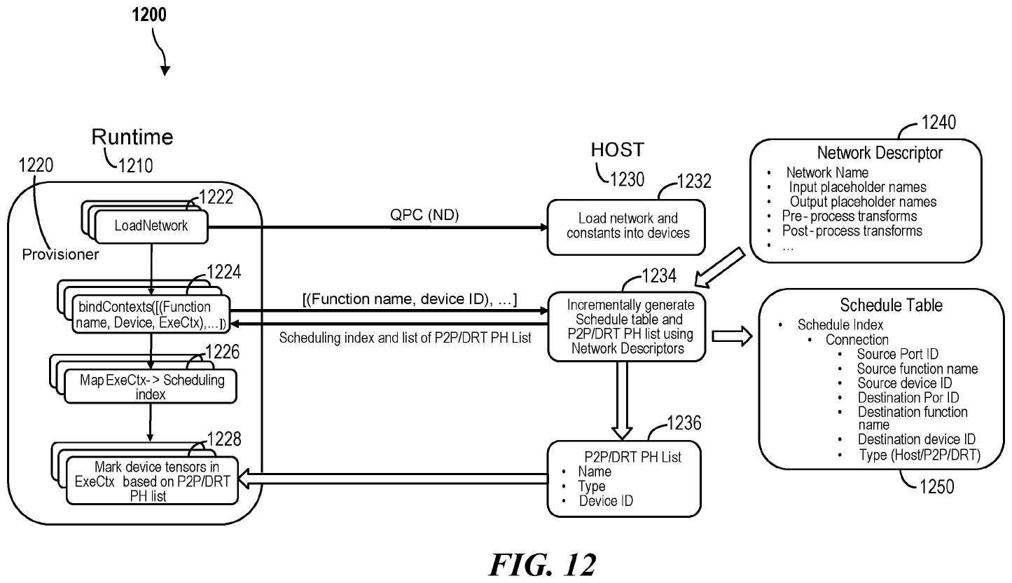

In some aspects of the present disclosure, a compiler splits the network into sub-neural networks, in which each sub-neural network may have multiple inputs and output ports, for example, as shown in FIG. 11. Although the runtime software can load the sub-neural networks to the AIIA devices, the runtime software is unaware of how to establish connections among the AIIA devices (e.g., AIIA 1 and/or AIIA 2) based on input and output types. In aspects of the present disclosure, the runtime software generates a scheduling policy based on the network descriptors generated at compile time, for example, as shown in FIG. 12.

FIG. 12 is a block diagram illustrating a scheduler policy generation flow for neural network acceleration architectures, in accordance with aspects of the present disclosure. In this example, a scheduler policy generation flow 1200 includes runtime software 1210, having a provisioner 1220, and a host 1230. The scheduler policy generation flow 1200 begins with a notification 1222 to load the sub-neural networks and constraints into the AIIA devices at block 1232. For example, a network descriptor 1240 is provided, which lists a network name, input placeholder (PH) names, output placeholder names, pre-process transforms, and post-process transforms. A bind context block 1224 incrementally generates a schedule table 1250 and a peer-to-peer (P2P)/distributed rounding table (DRT) place holder (PH) list 1236 using the network descriptor 1240 at block 1234. In this example, the P2P/DRT PH list 1236 includes a name, a type, and a device ID. In addition, the schedule table 1250 includes a schedule index, a connection, a source port ID, a source function name, a source device ID, a destination Port ID, a destination function name, a destination device ID, and a type (e.g., Host/P2P/DRT). At block 1226, an execution context is mapped to a scheduling index. At block 1228, device tensors are marked in the execution context based on the P2P/DRT PH list 1236.

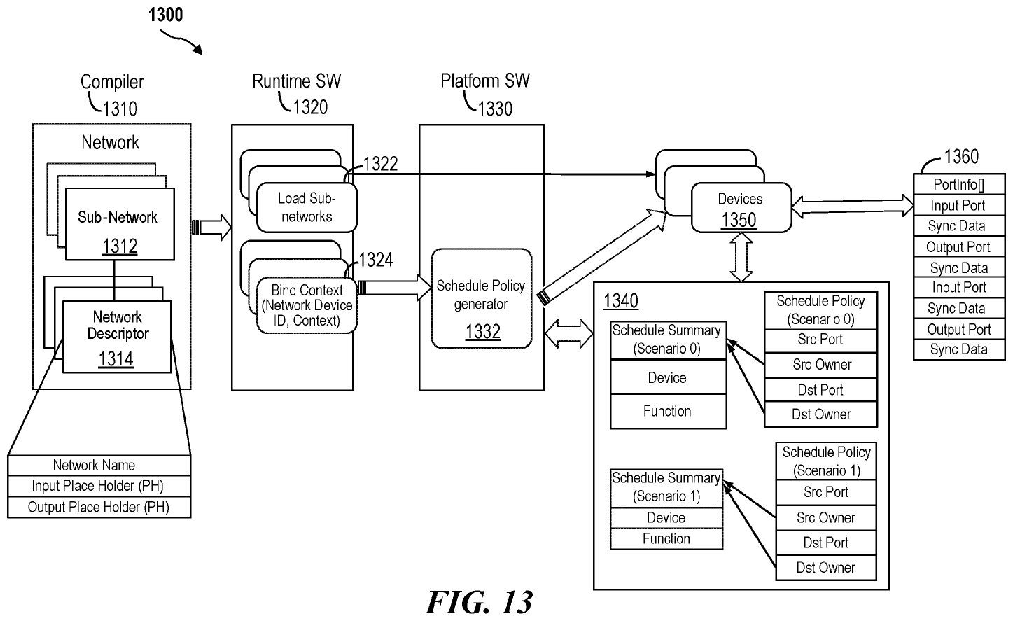

FIG. 13 is a block diagram 1300 further illustrating the scheduler policy generation flow of FIG. 12, in accordance with aspects of the present disclosure. In this example, a compiler 1310 generates sub-neural networks 1312, having a corresponding network descriptor 1314 including a network name, an input place holder, and an output place holder. In this example, the sub-neural networks 1312 are provided to runtime software 1320 to load the sub-networks at block 1322 and bind the context at block 1324. In aspects of the present disclosure, platform software 1330 includes a schedule policy generator 1332 to generate a schedule policy summary 1340 for various scenarios (e.g., scenario 0 and scenario 1). The schedule policy generator 1332 also generates schedule policies from the scenario 0 and the scenario 1 to define the source ports, the source owner, the destination port, and the destination owner. AIIA devices 1350 have a port information table 1360, including, input ports, synchronization data, and output ports (e.g., for scenario 0 and scenario 1).

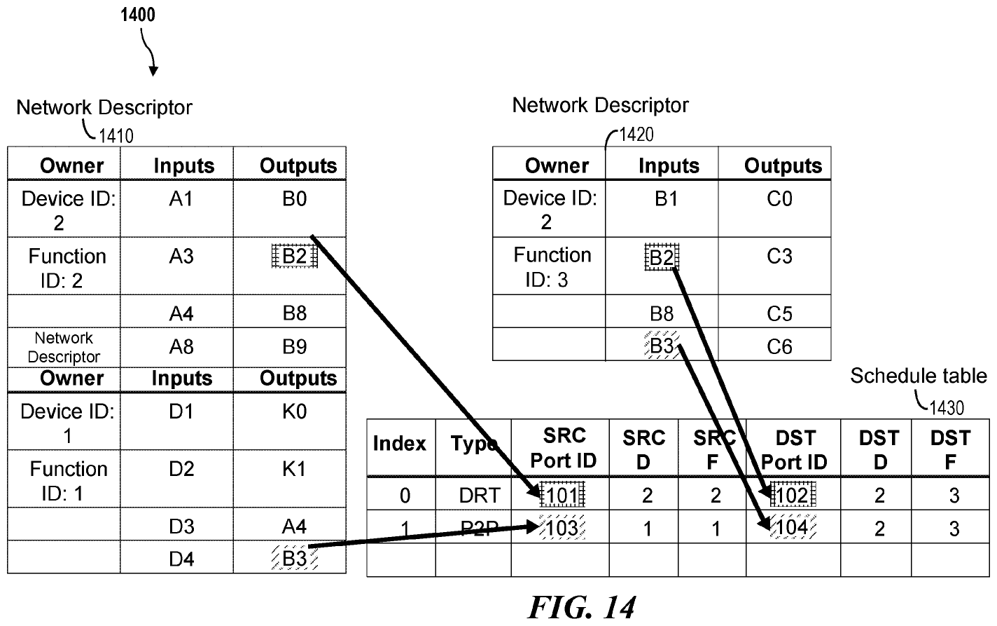

FIG. 14 is a block diagram illustrating the schedule table generation 1400 for the scheduler policy generation flow of FIG. 12, in accordance with aspects of the present disclosure. This example illustrates mapping of network descriptor tables (e.g., 1410, 1420) to a schedule table 1430. For example, an output B2 of Function ID 2 of the descriptor table 1410 is mapped to a source port ID 101 of the schedule table 1430. In addition, an output B3 of Function ID 1 of the descriptor table 1410 is mapped to a source port ID 103 of the schedule table 1430. Similarly, an input B2 of Function ID 3 of the descriptor table 1420 is mapped to a destination port ID 102. In addition, an input B3 of Function ID 3 of the descriptor table 1420 is mapped to a destination port ID 104 of the schedule table 1430.

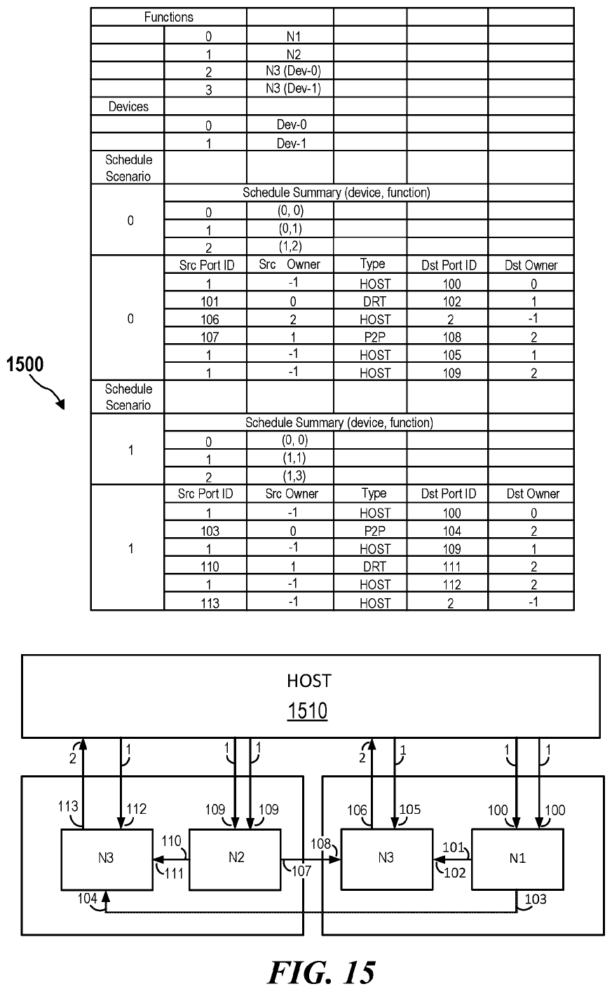

FIG. 15 is a block diagram illustrating a scheduler policy generation for sub-neural networks of a neural network acceleration architecture 1500, in accordance with aspects of the present disclosure. In this example, the neural network acceleration architecture 1500 includes a host 1510 and two instances of sub-neural network N3, as well as sub-neural network N1 and sub-neural network N2. The various sources and destination input and output ports are shown with their assigned numeric IDs and defined in the functions, devices, schedule scenarios, and schedule summaries according to devices and functions.

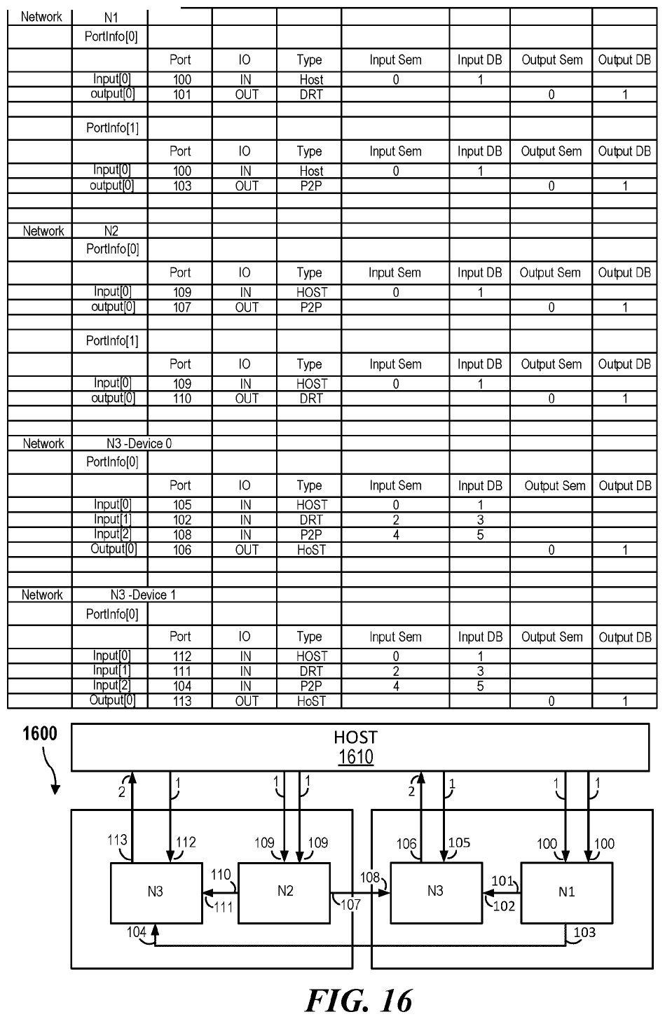

FIG. 16 is a block diagram illustrating a port information table for sub-neural networks of a neural network acceleration architecture 1600, in accordance with aspects of the present disclosure. In this example, the neural network acceleration architecture 1600 also includes a host 1610 and two instances of sub-neural network N3, as well as sub-neural network N1 and sub-neural network N2. The various sources and destination input and output ports are shown with their assigned numeric IDs and defined in the port information table according to the sub-neural networks N1, N2, and N3

During operation, power consumption of AIIA devices depends on the load of the AIIA devices. For example, massive neural networks involve co-processors to perform floating point operations as well as matrix/vector operations. Unfortunately, performing floating point and matrix/vector operations significantly increases the power consumption and the temperature of AIIA devices. In some aspects of the present disclosure, neural networks are split into compute intensive sub-neural networks and non-compute intensive sub-neural networks. The compute intensive sub-neural networks may be slower, which hinders the AIIA device performance.

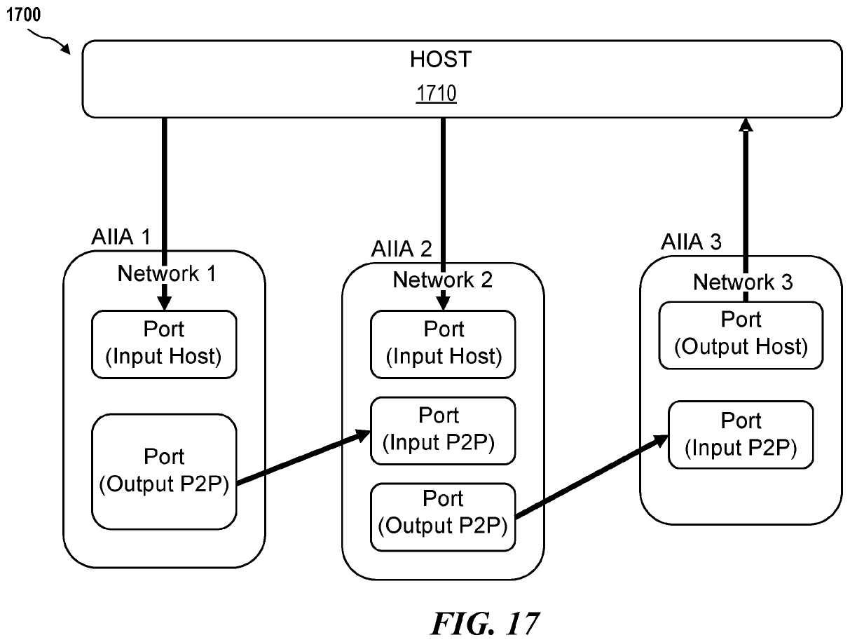

In one aspect of the present disclosure, a neural network is split into sub-neural networks and run on multiple AIIA devices, in which the same instances of the sub-neural networks are run on multiple AIIA devices by dynamically routing the data flow. In these aspects of the present disclosure, dynamic routing provides significant control over AIIA device power consumption and temperature. For example, improved performance is achieved by platform software the redirects the AIIA device inputs using output port information. In these aspects of the present disclosure, a neural network, prior to choosing an output, determines when platform software redirection information is detected. In response to detected redirection information, the neural network triggers/wakes a peer output port corresponding to the redirection information. In this example, the platform software running on a host continuously monitors the AIIA devices and outputs a redirection decision to reduce power consumption and/or temperature, for example, as shown in FIGS. 17-21.

FIG. 17 is a block diagram illustrating configuration connections of sub-neural networks for data flow path of a neural network acceleration architecture 1700, in accordance with aspects of the present disclosure. In this example, complete schedule information for the various scenarios is provided from a host 1710 to each of the AIIA devices (e.g., AIIA 1, AIIA 2, and AIIA 3). In the data flow path configuration, the host 1710 maps the AIIA devices (e.g., AIIA 1, AIIA 2, and AIIA 3) according to the loaded network ID. In addition, the AIIA devices (e.g., AIIA 1, AIIA 2, and AIIA 3) identify the sub-neural network the device is running, and extract schedule related information for their respective sub-neural network based on the loaded Network ID.

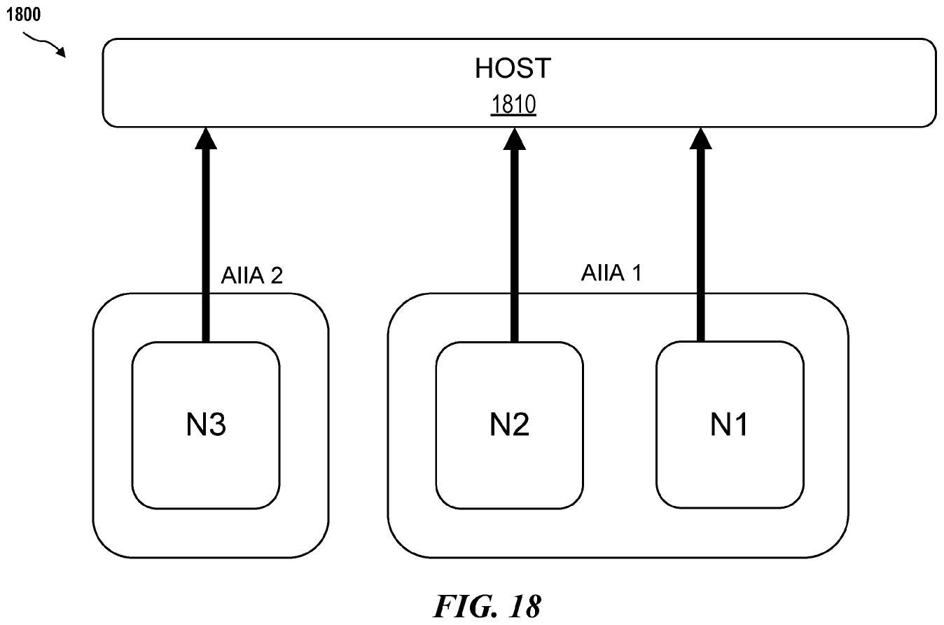

FIG. 18 is a block diagram illustrating host control path monitoring of a neural network acceleration architecture 1800, in accordance with aspects of the present disclosure. In this aspect of the present disclosure, a host 1810 periodically monitors sub-neural networks (e.g., N1, N2, N3) of the AIIA 1 device and the AIIA 2 device for performance and power information. This monitoring may include the power consumption of the AIIA 1 device and the AIIA 2 device, the temperature of the AIIA 1 device and the AIIA 2 device (e.g., each of the sensors), and the load of the AIIA 1 device and the AIIA 2 device. For example, the host 1810 uses these heuristics for data flow redirection decisions at runtime.

In some aspects of the present disclosure, an extra step at runtime is specified to plan the port connection information among the available AIIA devices (e.g., the AIIA 1 device and the AIIA 2 device). If specified, planning of the same instances of the sub-network on multiple devices and dynamically routing of the data flow is performed. The scheduling policy helps to set the data and control path among the devices prior to running an inference. The scheduling policy is deployed to all sub-networks in table format, which contains information about all the input and output ports, which is referred to as the port information table, for example, as shown in FIG. 16.

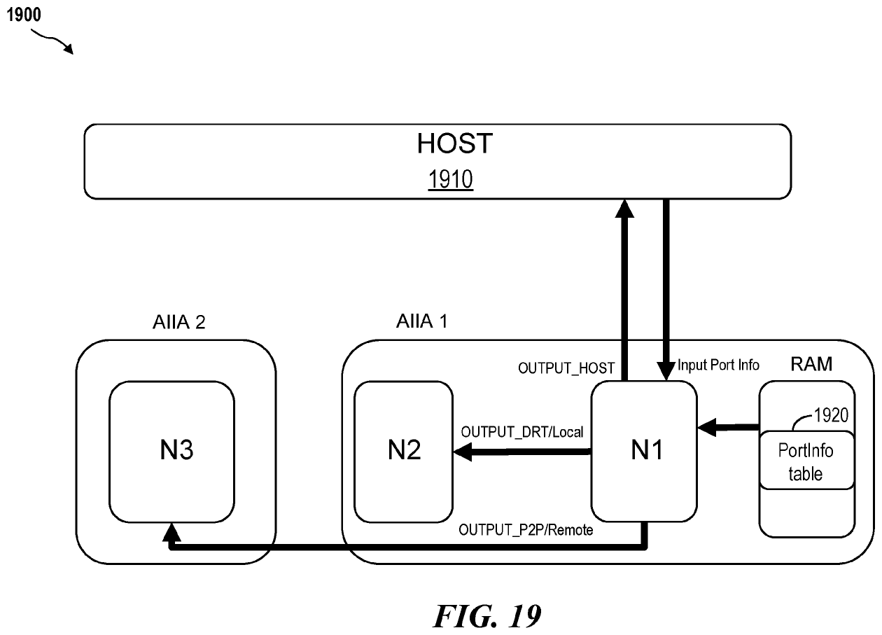

Aspects of the present disclosure monitor the sub-neural network parameters (e.g., power, temperature, and performance) at runtime. These aspects of the present disclosure dynamically route the inference data path to achieve optimal performance. For example, for each inference input, the host software sends redirection input to sub-networks, which is indexed into the port information table. The sub-neural networks look up the port information table before generating an output, and accordingly send the output to peer ports for synchronizing with these peer ports. In addition, the host platform software (SW) running on the host continuously monitors the AIIA devices and outputs redirection decisions according to the power, temperature and/or performance, for example, as shown in FIG. 19.

FIG. 19 is a block diagram illustrating an output port deployment of sub-neural networks of a neural network acceleration architecture 1900, in accordance with aspects of the present disclosure. In this example, a sub-network (e.g., N1, N2, N3) may output three different ports: (1) local—(Device Resident Tensor), (2) remote—(Peer-to-Peer), and (3) Host to enable communication between AIIA devices (e.g., AIIA 1, AIIA 2) and host 1910. In this example, the host 1910 (or device firmware (FW)) generates a port information table 1920, which may be extracted from a schedule table, for example, as shown in FIG. 12. In aspects of the present disclosure, the sub-neural networks (e.g., N1, N2, N3) may redirect the output to one of the ports, all of the ports, or designated ports on completion of an inference/output. For example, the sub-neural network N1 selects an output port (e.g. OUTPUT_HOST, OUTPUT DRT/Local, OUTPUT P2P/Remote) based on output redirection information. Although the sub-neural networks are shown with a single P2P, a single DRT, or a single local output port, it should be recognized that the sub-neural networks are not limited to single ports, such that a sub-neural network may be configured using any number of P2P/DRT/Host output ports.

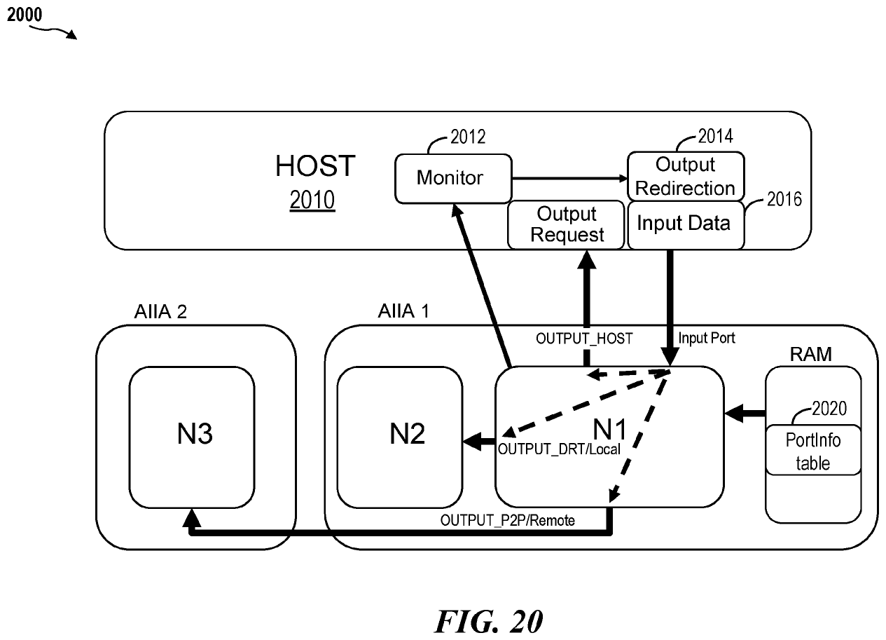

FIG. 20 is a block diagram illustrating a schedule policy selection of sub-neural networks of a neural network acceleration architecture 2000, in accordance with aspects of the present disclosure. In this configuration, a neural network is compiled in such a manner that an output redirection is read at runtime to redirect the output of the various sub-neural networks (e.g., N1, N2, and N3). In these aspects of the present disclosure, a monitor 2012 of a host 2010 monitors the performance of the AIIA 1 and AIIA 2 devices. Based on device heuristics, the monitor 2012 injects a direct memory access (DMA) request to an input data queue 2016 with a redirection value, such as an output redirection value 2014. For example, the output redirection value 2014 points to an index into a port information table 2020. In this example, the neural network looks up the port information table 2020 (e.g., portinfo[ ]) and identifies the output port.

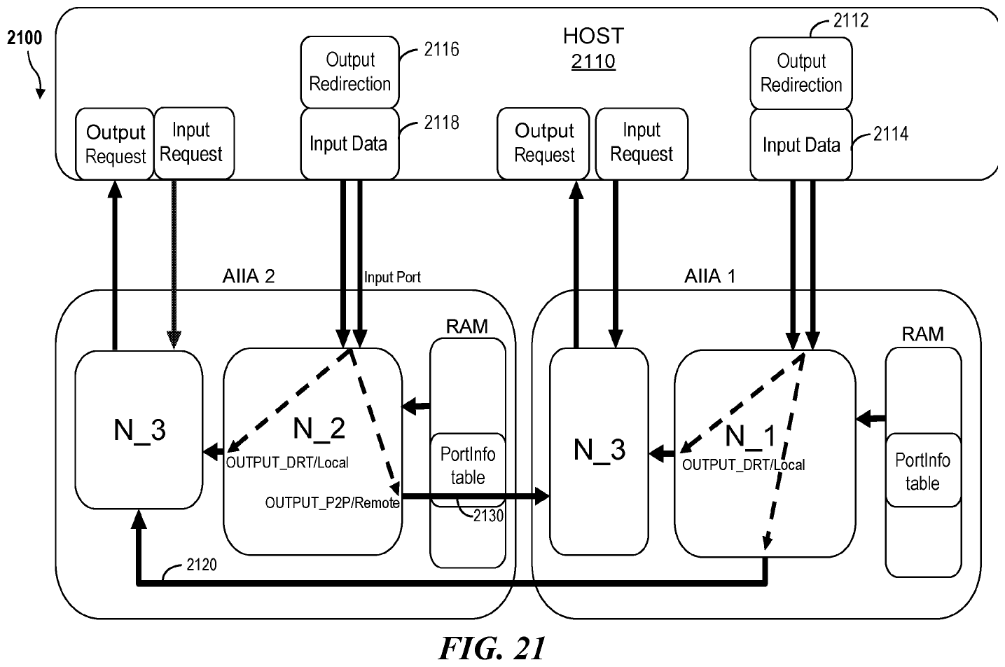

FIG. 21 is a block diagram illustrating an output port deployment of sub-neural networks of a neural network acceleration architecture 2100 having multiple instance of the same sub-neural network, in accordance with aspects of the present disclosure. In this configuration, two instances of the same sub-neural network (e.g., N_3) are running on two different AIIA cards. For example, a first inference flow direction 2120 and a second inference flow direction 2130 are shown. In operation, the first inference flow direction 2120 and the second inference flow direction 2130 are chosen based on an input from a host 2110. For example, the host 2110 selects the first inference flow direction 2120 by configuring an output redirection 2112 in an input data queue 2114. Similarly, the host 2110 selects the second inference flow direction 2130 by configuring an output redirection 2116 in an input data queue 2118. According to aspects of the present disclosure, this mechanism ensures the AIIA devices (e.g., AIIA 1 and AIIA 2) are consuming average power, average load, and/or a temperature.

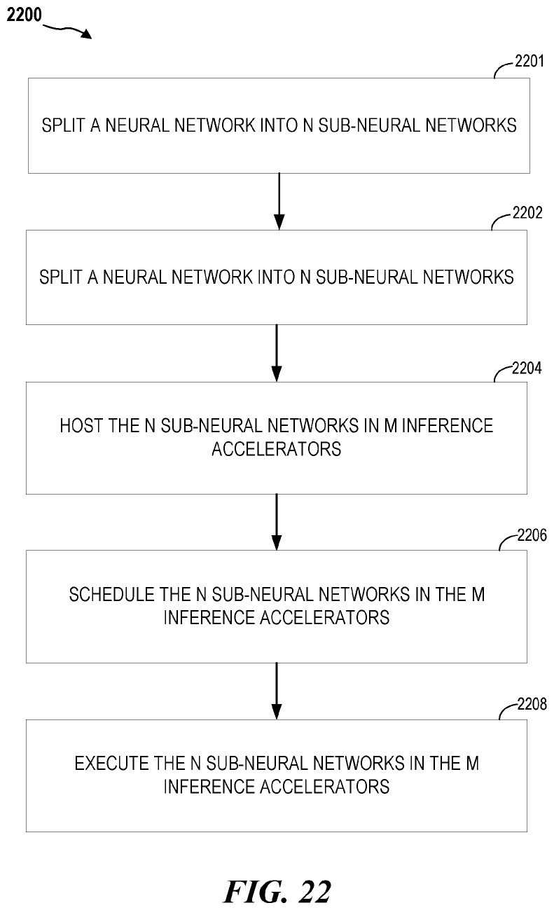

FIG. 22 illustrates a method for scheduling accelerating of machine learning on a computing device, in accordance with aspects of the present disclosure. A method 2200 begins at block 2201, in which a neural network is accessed. At block 2202, the neural network is split into N sub-neural networks. At block 2204, the N sub-neural networks are hosted in M inference accelerators. For example, as shown in FIG. 7, a neural network N is split into multiple sub-networks. The neural network N is split into sub-neural networks N1, N2, N3, . . . , Nn, each executed with a respective AIIA device (e.g., AIIA 1, AIIA 2, AIIA 3, . . . , AIIA N). In this daisy chain configuration, the sub-neural network N1 receives an input from the host that is processed through the sub-neural networks N2, N3 until the sub-neural network Nn generates an output for the host.

At block 2206, the N sub-neural networks are scheduled in the M inference accelerators. At block 2208, the N sub-neural networks are executed in the M inference accelerators. For example, as shown in FIG. 12, a scheduler policy generation flow 1200 begins with a notification 1222 to load the sub-neural networks and constraints into the AIIA devices at block 1232. For example, a network descriptor 1240 is provided, which lists a network name, input placeholder (PH) names, output placeholder names, pre-process transforms, and post-process transforms. A bind context block 1224 incrementally generates a schedule table 1250 and a P2P/DRT place holder (PH) list 1236 using the network descriptor 1240 at block 1234. In this example, the P2P/DRT PH list includes a name, a type, and a device ID. In addition the schedule table 1250 includes a schedule index, a connection, a source port ID, a source function name, a source device ID, a destination Port ID, a destination function name, a destination device ID, and a type (e.g., Host/P2P/DRT).

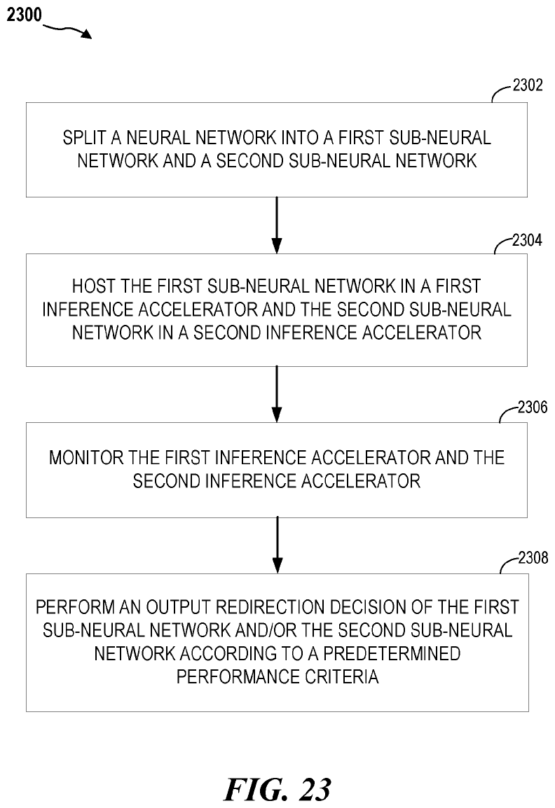

FIG. 23 illustrates a method for dynamic inference routing of accelerated machine learning on a computing device, in accordance with aspects of the present disclosure. A method 2300 begins at block 2302, in which a neural network is split into a first sub-neural network and a second sub-neural network. At block 2304, the first sub-neural network is hosted in a first inference accelerator and the second sub-neural network is hosted in a second inference accelerator. For example, as shown in FIG. 7, a neural network N is split into multiple sub-networks. The neural network N is split into sub-neural networks N1, N2, N3, . . . , Nn, each executed with a respective AIIA device.

At block 2306, the first inference accelerator and the second inference accelerator are monitored. At block 2308, an output redirection decision of the first sub-neural network and/or the second sub-neural network is performed according to a predetermined performance criteria. For example, as shown in FIG. 20, a monitor of the host monitors the performance of the AIIA 1 and AIIA 2 devices. Based on device heuristics, the monitor injects a direct memory access (DMA) request to an input queue with a redirection value. For example, the redirection value points to an index into the port information table. In this example, the neural network looks up the port information (portinfo[ ]) table and identifies the output port for which to perform redirection.

In some aspects, the method 2200 and the method 2300 may be performed by the SOC 100 (FIG. 1). That is, each of the elements of the method 2200 and the method 2300 may, for example, but without limitation, be performed by the SOC 100 or one or more processors (e.g., CPU 102 and/or NPU 108) and/or other components included therein.

Implementation examples are described in the following numbered clauses:

1. A processor implemented method for accelerating machine learning on a computing device, comprising:
accessing the neural network;
splitting the neural network into N sub-neural networks;
hosting the N sub-neural networks in M inference accelerators;
scheduling the N sub-neural networks in the M inference accelerators; and
executing the N sub-neural networks in the M inference accelerators.

2. The method of clause 1, in which scheduling comprises:
setting a data path and a control path of a first sub-neural network of the N sub-neural networks in a first inference accelerator of the M inference accelerators; and
setting a data path and a control path of a second sub-neural network of the N sub-neural networks in a second inference accelerator of the M inference accelerators.

3. The method of clause 2, further comprising:
monitoring the first inference accelerator and the second inference accelerator; and
dynamically adjusting the data path and/or the control path of the first sub-neural network and/or the second sub-neural network according to a predetermined performance criteria.

4. The method of clause 3, in which dynamically adjusting comprises:
identifying a peer output port in response to dynamically adjusting the data path and/or the control path; and
waking the peer output port to dynamically adjust the data path and/or the control path.

5. The method of any of clauses 2-4, further comprising:
assigning a unique port identification to each input port and output port of the first inference accelerator and the second inference accelerator.

6. The method of any of clauses 1-5, in which N=M and N and M are integers greater than one.

7. The method of any of clauses 1-5, in which N<M and N and M are integers greater than one.

8. A non-transitory computer-readable medium having program code recorded thereon for accelerating machine learning on a computing device, the program code being executed by a processor and comprising:
program code to access a neural network;
program code to split the neural network into N sub-neural networks;
program code to host the N sub-neural networks in M inference accelerators; and
program code to execute the N sub-neural networks in the M inference accelerators.

9. The non-transitory computer-readable medium of clause 8, in which the program code to schedule comprises:
program code to set a data path and a control path of a first sub-neural network of the N sub-neural networks in a first inference accelerator of the M inference accelerators; and
program code to set a data path and a control path of a second sub-neural network of the N sub-neural networks in a second inference accelerator of the M inference accelerators.

10. The non-transitory computer-readable medium of clause 9, further comprising:
program code to monitor the first inference accelerator and the second inference accelerator; and
program code to dynamically adjust the data path and/or the control path of the first sub-neural network and/or the second sub-neural network according to a predetermined performance criteria.

11. The non-transitory computer-readable medium of clause 10, in which the program code to dynamically adjust comprises:
program code to identify a peer output port in response to dynamically adjusting the data path and/or the control path; and
program code to wake the peer output port to dynamically adjust the data path and/or the control path.

12. The non-transitory computer-readable medium of any of clauses 9-11, further comprising:
program code to assign a unique port identification to each input port and output port of the first inference accelerator and the second inference accelerator.

13. A method for dynamic inference routing of accelerated machine learning on a computing device, comprising:
splitting a neural network into a first sub-neural network and a second sub-neural network;
hosting the first sub-neural network in a first inference accelerator and the second sub-neural network in a second inference accelerator;
monitoring the first inference accelerator and the second inference accelerator; and
performing an output redirection decision of the first sub-neural network and/or the second sub-neural network according to a predetermined performance criteria.

14. The method of clause 13, further comprising:
determining whether a platform software redirection is detected prior to choosing an output port; and
waking a peer output port in response to detecting the platform software redirection.

15. The method of any of clauses 13 or 14, further comprising dynamically scheduling the first sub-neural network in the first inference accelerator and the second sub-neural network in the second inference accelerator.

16. The method of clause 15, in which dynamically scheduling comprises:
adjusting a data path and a control path of the first sub-neural network in the first inference accelerator at runtime; and
adjusting a data path and a control path of the second sub-neural network in the second inference accelerator at runtime.

17. The method of any of clauses 13-16, in which the predetermined performance criteria comprises a power consumption, a temperature, and/or a load of the first inference accelerator and/or the second inference accelerator.

18. A non-transitory computer-readable medium having program code recorded thereon for dynamic inference routing of accelerated machine learning on a computing device, the program code being executed by a processor and comprising:
program code to split a neural network into a first sub-neural network and a second sub-neural network;
program code to host the first sub-neural network in a first inference accelerator and the second sub-neural network in a second inference accelerator;
program code to monitor the first inference accelerator and the second inference accelerator; and
program code to perform an output redirection decision of the first sub-neural network and/or the second sub-neural network according to a predetermined performance criteria.

19. The non-transitory computer-readable medium of clause 18, further comprising:
program code to determine whether a platform software redirection is detected prior to choosing an output port; and
program code to wake a peer output port in response to detecting the platform software redirection.

20. The non-transitory computer-readable medium of any of clause 18 or 19, further comprising:
program code to adjust a data path and a control path of the first sub-neural network in the first inference accelerator at runtime; and
program code to adjust a data path and a control path of the second sub-neural network in the second inference accelerator at runtime to dynamically schedule the first sub-neural network in the first inference accelerator and the second sub-neural network in the second inference accelerator.

The system for accelerating machine learning includes means for dynamically routing inference between the sub-neural networks of a neural network acceleration architecture. In one aspect, the routing means may be the switch device 302 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As described, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As described, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be executed or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be executed as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as described, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described, may be downloaded and/or otherwise obtained by a user terminal and/or base station as applicable. For example, such a device can be coupled to a server to facilitate the transfer of means for performing the methods described. Alternatively, various methods described, may be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor implemented method for accelerating machine learning on a computing device, comprising:
accessing a neural network;
splitting the neural network into N sub-neural networks;
hosting the N sub-neural networks in M inference accelerators;
scheduling the N sub-neural networks in the M inference accelerators; and
executing the N sub-neural networks in the M inference accelerators.

2. The method of claim 1, in which scheduling comprises:
setting a data path and a control path of a first sub-neural network of the N sub-neural networks in a first inference accelerator of the M inference accelerators; and
setting a data path and a control path of a second sub-neural network of the N sub-neural networks in a second inference accelerator of the M inference accelerators.

3. The method of claim 2, further comprising:
monitoring the first inference accelerator and the second inference accelerator; and
dynamically adjusting the data path and/or the control path of the first sub-neural network and/or the second sub-neural network according to a predetermined performance criteria.

4. The method of claim 3, in which dynamically adjusting comprises:
identifying a peer output port in response to dynamically adjusting the data path and/or the control path; and
waking the peer output port to dynamically adjust the data path and/or the control path.

5. The method of claim 2, further comprising:
assigning a unique port identification to each input port and output port of the first inference accelerator and the second inference accelerator.

6. The method of claim 1, in which N=M and N and M are integers greater than one.

7. The method of claim 1, in which N<M and N and M are integers greater than one.

8. A non-transitory computer-readable medium having program code recorded thereon for accelerating machine learning on a computing device, the program code being executed by a processor and comprising:
program code to access a neural network;
program code to split the neural network into N sub-neural networks;
program code to host the N sub-neural networks in M inference accelerators;
program code to schedule the N sub-neural networks in the M inference accelerators; and
program code to execute the N sub-neural networks in the M inference accelerators.

9. The non-transitory computer-readable medium of claim 8, in which the program code to schedule comprises:
program code to set a data path and a control path of a first sub-neural network of the N sub-neural networks in a first inference accelerator of the M inference accelerators; and
program code to set a data path and a control path of a second sub-neural network of the N sub-neural networks in a second inference accelerator of the M inference accelerators.

10. The non-transitory computer-readable medium of claim 9, further comprising:
program code to monitor the first inference accelerator and the second inference accelerator; and
program code to dynamically adjust the data path and/or the control path of the first sub-neural network and/or the second sub-neural network according to a predetermined performance criteria.

11. The non-transitory computer-readable medium of claim 10, in which the program code to dynamically adjust comprises:
program code to identify a peer output port in response to dynamically adjusting the data path and/or the control path; and
program code to wake the peer output port to dynamically adjust the data path and/or the control path.

12. The non-transitory computer-readable medium of claim 9, further comprising:
program code to assign a unique port identification to each input port and output port of the first inference accelerator and the second inference accelerator.

13. A method for dynamic inference routing of accelerated machine learning on a computing device, comprising:
splitting a neural network into a first sub-neural network and a second sub-neural network;
hosting the first sub-neural network in a first inference accelerator and the second sub-neural network in a second inference accelerator;
monitoring the first inference accelerator and the second inference accelerator; and
performing an output redirection decision of the first sub-neural network and/or the second sub-neural network according to a predetermined performance criteria.

14. The method of claim 13, further comprising:
determining whether a platform software redirection is detected prior to choosing an output port; and
waking a peer output port in response to detecting the platform software redirection.

15. The method of claim 13, further comprising dynamically scheduling the first sub-neural network in the first inference accelerator and the second sub-neural network in the second inference accelerator.

16. The method of claim 15, in which dynamically scheduling comprises:
adjusting a data path and a control path of the first sub-neural network in the first inference accelerator at runtime; and
adjusting a data path and a control path of the second sub-neural network in the second inference accelerator at runtime.

17. The method of claim 13, in which the predetermined performance criteria comprises a power consumption, a temperature, and/or a load of the first inference accelerator and/or the second inference accelerator.

18. A non-transitory computer-readable medium having program code recorded thereon for dynamic inference routing of accelerated machine learning on a computing device, the program code being executed by a processor and comprising:
program code to split a neural network into a first sub-neural network and a second sub-neural network;
program code to host the first sub-neural network in a first inference accelerator and the second sub-neural network in a second inference accelerator;
program code to monitor the first inference accelerator and the second inference accelerator; and
program code to perform an output redirection decision of the first sub-neural network and/or the second sub-neural network according to a predetermined performance criteria.

19. The non-transitory computer-readable medium of claim 18, further comprising:
program code to determine whether a platform software redirection is detected prior to choosing an output port; and
program code to wake a peer output port in response to detecting the platform software redirection.

20. The non-transitory computer-readable medium of claim 18, further comprising:
program code to adjust a data path and a control path of the first sub-neural network in the first inference accelerator at runtime; and
program code to adjust a data path and a control path of the second sub-neural network in the second inference accelerator at runtime to dynamically schedule the first sub-neural network in the first inference accelerator and the second sub-neural network in the second inference accelerator.
